(19) United States
(12) Patent Application Publication
(10) Pub. No.: US 2012/0245737 A1
(43) Pub. Date: Sep. 27, 2012

(54) REAL-TIME CONTROL METHOD AND GAS PURIFICATION SYSTEM FOR SOLVENT BASED CAPTURE SYSTEMS

(75) Inventors: ZHENG LIU, KNOXVILLE, TN (US); NARESHKUMAR B. HANDAGAMA, KNOXVILLE, TN (US); RASESH R. KOTDAWALA, KNOXVILLE, TN (US); BARATH BABURAO, KNOXVILLE, TN (US); VIKRAM S. SHABDE, PEARLAND, TX (US)

(73) Assignee: ALSTOM TECHNOLOGY LTD, BADEN (CH)

(21) Appl. No.: 13/402,073

(22) Filed: Feb. 22, 2012

Related U.S. Application Data
(60) Provisional application No. 61/466,181, filed on Mar. 22, 2011.

(51) Int. Cl. B01D 53/14; G05B 21/02

(52) U.S. Cl. 700/271; 96/234; 96/242

(57) ABSTRACT

Gas purification systems generally include an analyzing unit including a plurality of sensors and/or probes for continuously analyzing a solvent cyclic capacity in real time, the plurality of sensors and/or probes in fluid communication with rich amine and lean amine solution carrying conduits and the water wash conduits; and a system control unit configured to receive outputs from the analyzing unit for monitoring and controlling the solvent cyclic capacity in real time. Also disclosed are computer implemented methods for providing the real time control.

### CROSS REFERENCE TO RELATED APPLICATIONS

The present application claims the benefit of U.S. Provisional Application No. 61/466,181 filed on Mar. 22, 2011, incorporated herein by reference in its entirety.

### BACKGROUND

The present disclosure generally relates to a real time control method and gas purification system for absorbing carbon dioxide (CO₂) in a solvent based capture system.

Current solvent-based CO₂ capture systems from mixed gas streams, e.g., flue gas, require 20 to 30% of the power generated by the power plant, which significantly reduces the net available electrical output. In addition to the operating costs, solvent management costs are also significant.

The amount of acid gases contained within a given amount of amine is important in order to assess the quality of the solvent in the solvent based processes. It is generally desirable to utilize all of the available cyclic capacity of the amine based solvents such that the solvent flow rates are also optimized. As used herein, the term “cyclic capacity” is generally equal to the rich amine loading minus the lean amine loading. The rich amine loading is determined by measuring the amount of acid gas contained in the amine stream exiting the amine contactor and is typically represented in a mol ratio ((mol of CO₂+mol H₂S)/mol amine) The acid gas loading is a critical parameter for solvent regeneration since desorption energy is a function of loading.

The lean amine loading is determined by measuring the amount of acid gas contained in the amine stream exiting the amine regenerator and is measured in the same manner as the rich amine loading described above. This is a much easier and more reliable measurement, though simulation results can still be used to check the collected data. Lean amine loading values will vary, depending on the type of amine being used. Lean amine loading will be affected by the reboiler duty, reflux ratio and the number of fractionation stages within the Amine Still. If the lean amine is not properly stripped of the acid gases, corrosion may be encountered in the hot portions of the plant, e.g., the amine reboiler section and associated piping. Also, if the lean amine loading is too high, the ability of the amine to remove the acid gases from the inlet gas stream in the amine contactor may be diminished and product specifications may not be met. In view of the foregoing, the amine concentration is a transient parameter with respect to location and time.

Current measurement processes include withdrawing samples and analyzed off-line. Because the amine concentration is transient with respect to location and time, the time lag from obtaining the results can lead to errors in process control and introduce unwanted outcomes.

Currently, there is a lack of control strategies to provide real time control of the solvent stripping temperature and steam pressure as well as to regulate solvent circulate flow rates to ensure the maintenance of optimized cyclic capacity, stripping temperature and reboiler steam flow (i.e., steam consumption). Accordingly, it would be desirable to have real time control methodology and systems capable of effectively and rapidly optimizing the solvent circulate rate, the solvent stripping temperature, and steam pressure.

### BRIEF SUMMARY

Disclosed herein are gas purification systems for removal of gaseous acidic components from a gas stream and real-time control methods. In one embodiment, the gas purification system for removal of gaseous acidic components from a gas stream comprises an absorption unit comprising at least one amine based wash solution section configured to receive the gas stream comprising the acidic components to be removed and at least one water wash section downstream from the amine based wash section, wherein the at least one water wash section is configured to receive the gas stream from the amine based wash solution section, wherein the absorption unit provides a rich amine solution and a flue gas depleted of acidic gases; a regeneration unit in fluid communication with the absorption unit for regenerating the rich amine solution from the absorption unit by removing the acidic gases therein and providing a lean amine solution for reuse in the absorption unit; an analyzing unit comprising a plurality of sensors for continuously analyzing a solvent cyclic capacity in real time, the plurality of sensors in fluid communication with rich amine and lean amine solution carrying conduits and the water wash conduits; a system control unit configured to receive outputs from the analyzing unit for monitoring and controlling the solvent cyclic capacity in real time.

A computer implemented method for monitoring and controlling a solvent based gas purification system comprising an absorption unit and a regeneration unit comprises receiving real time data indicative of solvent cyclic capacity from at least one sensor in fluid communication with rich and/or lean amine solution carrying conduits and/or water wash conduits of the system; and comparing the real time data with a predetermined threshold value; wherein in response to the real time data not meeting the predetermined threshold value, adjusting a solvent circulate rate and/or stripping temperature in the regeneration unit, and in response to the real time data meeting the predetermined threshold value, measuring a CO₂ removal efficiency percentage.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 schematically illustrates an amine based gas purification system in accordance with an exemplary embodiment;

FIG. 2 illustrates a block diagram in accordance with an exemplary embodiment;

FIG. 3 illustrates a block diagram in accordance with an exemplary embodiment;

FIG. 4 illustrates a block diagram in accordance with an exemplary embodiment; and

FIG. 5 illustrates a block diagram in accordance with an exemplary embodiment.

### DETAILED DESCRIPTION

The present invention generally relates to a control and solvent management system for an amine based solvent capture system. More particularly, there is provided a real time control and solvent management system for amine based solvent capture systems.

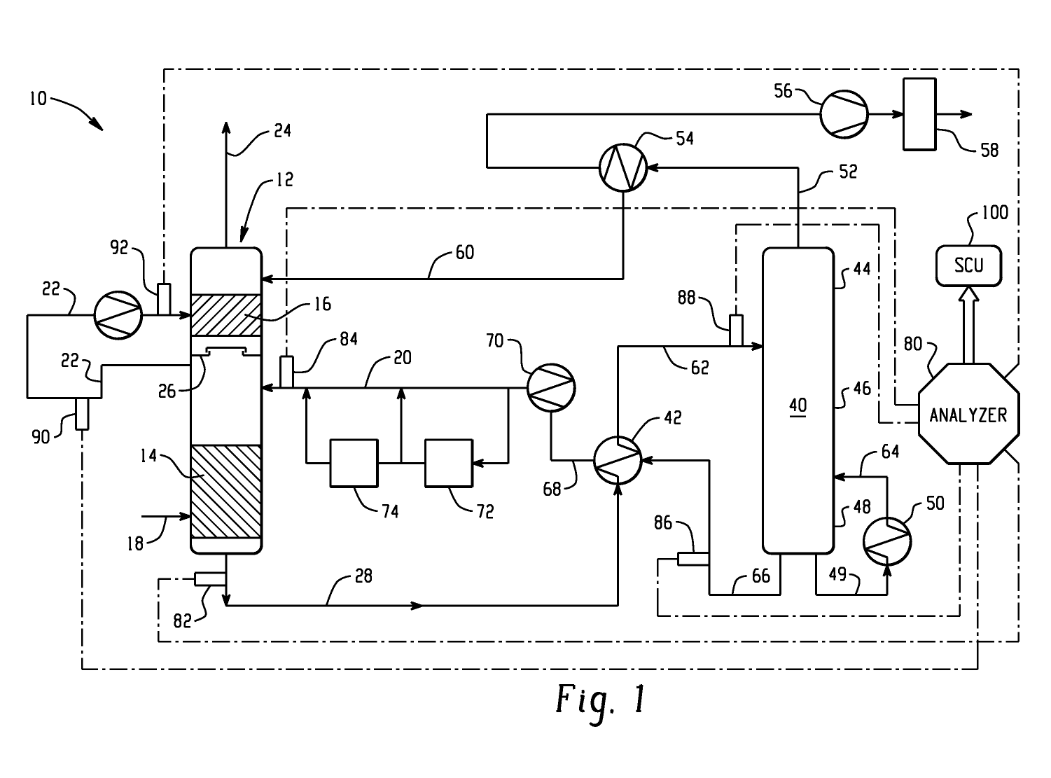

FIG. 1 schematically illustrates an exemplary amine based capture system generally designated by reference numeral 10 in accordance with one embodiment for removing carbon dioxide and contaminants from a gas stream. The illustrated amine based solvent capture system 10 is optimally configured for treating pressure-less flue gas. However, the control and solvent management system described herein is not intended to be limited to the illustrated amine based solvent capture system. The control and solvent management system can be used in various other types of solvent based capture systems including, but not limited to, ammonia, amino acid salts, ionic liquids, and the like.

The exemplary amine based capture system includes an absorption unit 12 arranged to allow contact between the gas stream to be purified and one or more wash liquids. The absorption unit represented in FIG. 1 includes a CO₂ absorption section 14 and a water wash section 16. Intermediate the absorption and water wash section is a condenser 26. In some systems, these sections are a packed bed column Flue gas, from which CO₂ and other contaminants are to be removed, is fed to the absorption unit 12 via line 18.

In the CO₂ absorption section 14, the flue gas is contacted with a first wash liquid comprising an amine compound, e.g., by bubbling the flue gas through the first wash liquid or by spraying the first wash liquid into the flue gas. The first wash liquid can be fed to the absorption unit via line 20. Exemplary amine compounds include, without limitation, monoethanolamine (MEA), diethanolamine (DEA), methyldiethanolamine (MDEA), diisopropylamine (DIPA), and aminoethoxyethanol (diglycolamine), and combinations thereof The amine based wash solution may further include a promoter and/or an inhibitor. The promoters are generally utilized to enhance the reaction kinetics involved in the capture of CO₂. Exemplary promoters include an amine such as piperazine or enzymes such as carbonic anhydrase or its analogs. The promoters may be in the form of a solution or immobilized on solid or semisolid surfaces. Inhibitors are generally provided to minimize corrosion and solvent degradation. In the CO₂ absorption section 102, CO₂ from the flue gas is absorbed in the first wash liquid.

The flue gas depleted of CO₂ then enters the water wash section 16 of the absorption unit 12, wherein the water wash section 16 is arranged to allow contact between the flue gas and a second wash liquid, which is generally water. The second wash liquid is fed to the absorption unit via line 22. In the water wash section 16, contaminants remaining in the flue gas when it leaves the CO₂ absorption section 14 are absorbed. The contaminants can include the water soluble volatile degradation products such as ammonia, formaldehyde, degradation products of amine, and the like. The flue gas, which is now depleted of CO₂ and contaminants, leaves the absorption unit via line 24 and is typically discharged into the environment. Optionally, the treated flue gas depleted of CO₂ and contaminants may undergo further processing, e.g., particulate removal via a filter (not shown), prior to being released to the environment.

The wash water utilized in wash water section 16 is generated self sufficient by condensing part of the water vapor contained in the treated gas coming from the CO₂ absorption section 14. Excess water is not discharged as an effluent but instead is sent to the amine wash solution loop via line 22. Flue gas depleted of CO₂ and contaminants leaves the absorption unit via line 24. The used first and second wash liquids containing absorbed CO₂ and contaminants leave the absorption unit via line 28.

The used first and second wash liquids may be recycled via a regenerator unit 40, wherein the acid gases such as CO₂ are separated from the wash liquids. A portion of the used wash liquids can be heated via heat exchanger 42 and fed to a mid-section 44 of the regenerator (e.g., typically 100 to 150° C.) via line 62 or optionally fed to the top portion 46 of the regenerator unit, which is at a markedly lower temperature so as to minimize the energy losses due to the latent heat of the water vapor (e.g., typically 40 to 60° C.). The regenerated wash solution is withdrawn from the lower section 48 via line 49 and provided to a reboiler 50 positioned downstream of the regenerator unit 40 and arranged to receive the regenerated wash solution. The separated CO₂ leaves the regenerator unit 40 via line 52. The separated CO₂ can be cooled in cooler 54 to form condensate from any water vapor entrained therein, compressed in compressor 56, and dehydrated, if desired at 58. Condensate from the cooler may be feed back to the water wash section via line 60.

The reboiler boils the regenerated wash solution to form steam 64 and a hot regenerated wash solution 66 (lean amine solution). The hot regenerated was solution is provided to the absorption unit 12 for removal of gaseous contaminants form the gas stream 18. To take advantage of the thermal energy present therein, the hot regenerate wash solution is first provided to the heat exchanger 42 and may also be fed to a cooler 68 via line 70. Prior to reintroduction into the absorption unit 12, the regenerated lean amine solution may be filtered in amine filter 72 and reclaimed in reclaimer 74. Alternatively, in some systems, the hot regenerated wash solution may be provided directly to the absorption unit 12 for reuse.

In one embodiment, the system 10 includes an analyzer 80 in communication with a system control unit 100. The analyzer 80 includes a plurality of sensors and/or probes 82, 84, 86, 88, 90 and 92 in communication with various conduits for real time optimizing the amine concentration and CO₂ level therein. The system control unit 100 is configured to adjust one or more operating parameters such as, but not limited to, solvent circulation rate, regenerator temperature, water wash circulation rate and/or amount, stream flow rate, and the like, in response thereto. The analyzer itself is suitable for real time analysis of amine and CO₂ loading. As such, the sensors and/or probes may be configured to measure an attenuated total reflectance Fourier Transform Infra Red signal representative of the solvent; a Raman spectrum signal representative of the solvent; a pH of the solvent; a refractive index of the solvent; a conductivity of the solvent; a density of the solvent, and various combinations thereof The adjustment of operating parameters described herein can be implemented in software (e.g., firmware), hardware, or a combination thereof In exemplary embodiments, the methods described herein are implemented in software, as an executable program, and is executed by a special or general-purpose digital computer, such as a personal computer, workstation, minicomputer, or mainframe computer.

In operation, the system control unit 100 will provide a signal to the solvent flow controller, wash/cooling water circulation controller, and steam flow controller of reboiler to optimize the solvent circulate rate, regeneration temperature, regenerator pressure, and water circulate rate in the water wash column according to the feedback information from the analyzer 80 in combination with other result effective parameters such as CO₂ content of the gas phase and CO₂ removal. The analyzer 80 communicates with liquid flows of the amine based solvent capture system 10 and monitors the amine concentration and CO₂ loading in the liquid phase. The analyzer may further include a sampling flow cell, particulate matter filter, sampling lines and the like for periodically sampling the solvent. By way of example, the analyzer may be a Laser Raman and ATR-FTIR analyzer working together via fiber optic probes disposed in conduits, e.g., 20, 28, 22, and the like. The analyzer can be configured to measure amine and CO₂ loading in liquid phase. A data acquisition system is linked to the analyzer 80.

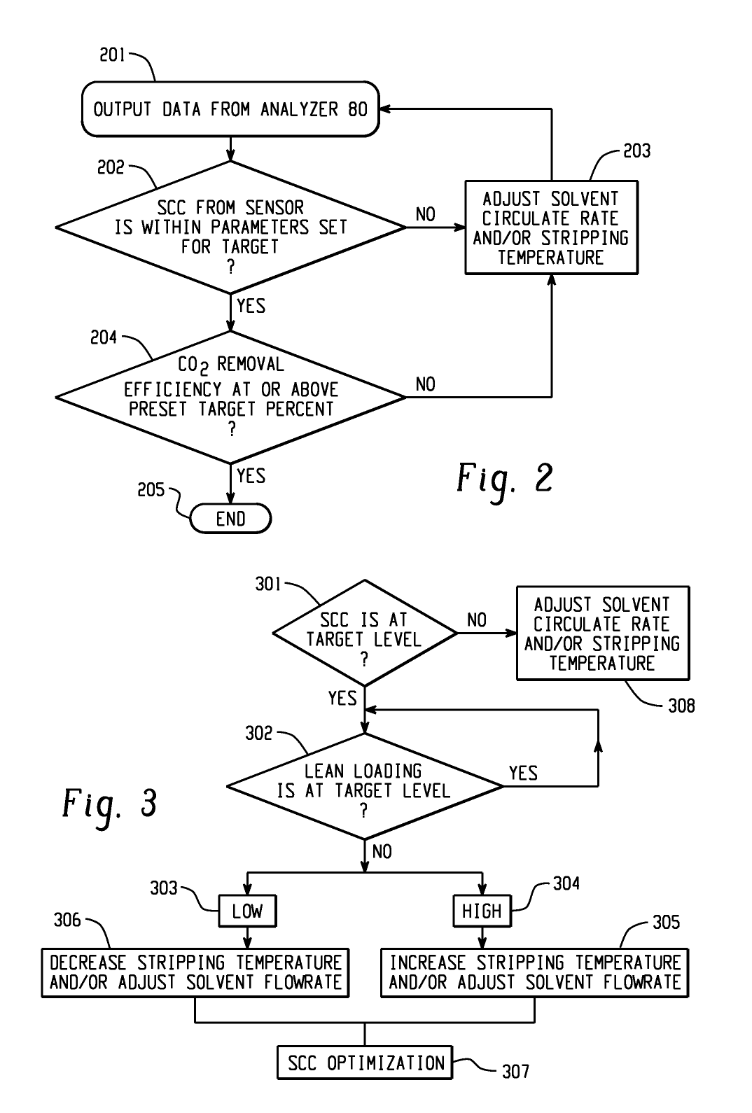

By way of example, the analyzer 80 and SCU 100 can be configured to monitor the real time solvent cyclic capacity by measuring the difference between the rich amine entering the regeneration unit and the lean amine leaving the regeneration unit. A desired set point can be determined such that any subsequent deviation can be continuously corrected. Alternatively, the CO₂ loading can be monitored by measuring the CO₂ loading in the lean amine and comparing this to the flue gas flow rate and concentration of CO₂ in the flue gas. In this manner, the lean amine flow rate can be adjusted to maximize the CO₂ removal efficiency. Still further, based on the CO₂ concentration in the flue gas and the flue gas flow rate, the desired stripping of the rich amine can be calculated to provide a desired CO₂ capture in the absorption unit. This signal can then be used to provide the optimal steam flow rate in the reboiler. These embodiments and others are described in greater detail in FIGS. 2-5 below.

FIG. 2 schematically illustrates a block diagram of a control algorithm implemented by a computer that constructs the system control unit 100. At block 201, outputs are provided by the analyzer 80 to the system control unit 100 and processed at block 202. In this manner, the solvent cyclic capacity can be monitored and optimized for peak performance and efficiency. If the cyclic capacity is outside the defined limits, the solvent circulation and stripping temperature can be adjusted in block 203. If cyclic capacity is within the defined parameters, CO₂ removal efficiency is measured at block 204, e.g., removal efficiency can be set to equal to or greater than 90%. If removal efficiency meets these criteria, no adjustments are made, which means that the lean and rich loading is satisfactory as defined by the preset limits If removal efficiency is below the preset limit, for example, less than 90% then block 203 is repeated.

FIG. 3 illustrates a block diagram of another exemplary embodiment. At block 301, it is first determined whether the solvent cyclic capacity (SCC) is at the target level. If no, the controller will perform the embodiment generally illustrated in FIG. 2 so as to insure the SCC is operating at the predetermined target level, i.e. solvent circulation and/or stripping temperature may be adjusted as shown therein. If the SCC meets the target level, the SCC is optimized Optimization in this exemplary embodiment includes measuring the lean amine loading at block 302 to determine whether the lean amine loading falls within a preset level based on the data from probes and/or sensors 84 and 86 in FIG. 1. If yes, the control process flow will return to block 301. If no, a determination will be made as to whether the lean amine loading is too low or too high at blocks 303 and 304. A low lean amine loading is indicative of the solvent being over-stripped. In this mode, the control will be configured to readjust the regenerator condition to an optimal mode as shown in block 306, i.e., the solvent temperature may be decreased and/or the solvent circulate rate will be adjusted. On the other hand, if no with a higher lean amine loading, the control will perform the operation of either increasing the stripping temperature or the solvent circulate rate or both until an optimal operation mode is reached as shown in block 305. It should be noted that both the temperature increase and/or decrease operations can be conducted at the same time as the solvent flow rate adjustment. The block diagram ends with the SCC being optimized as defined by the operator.

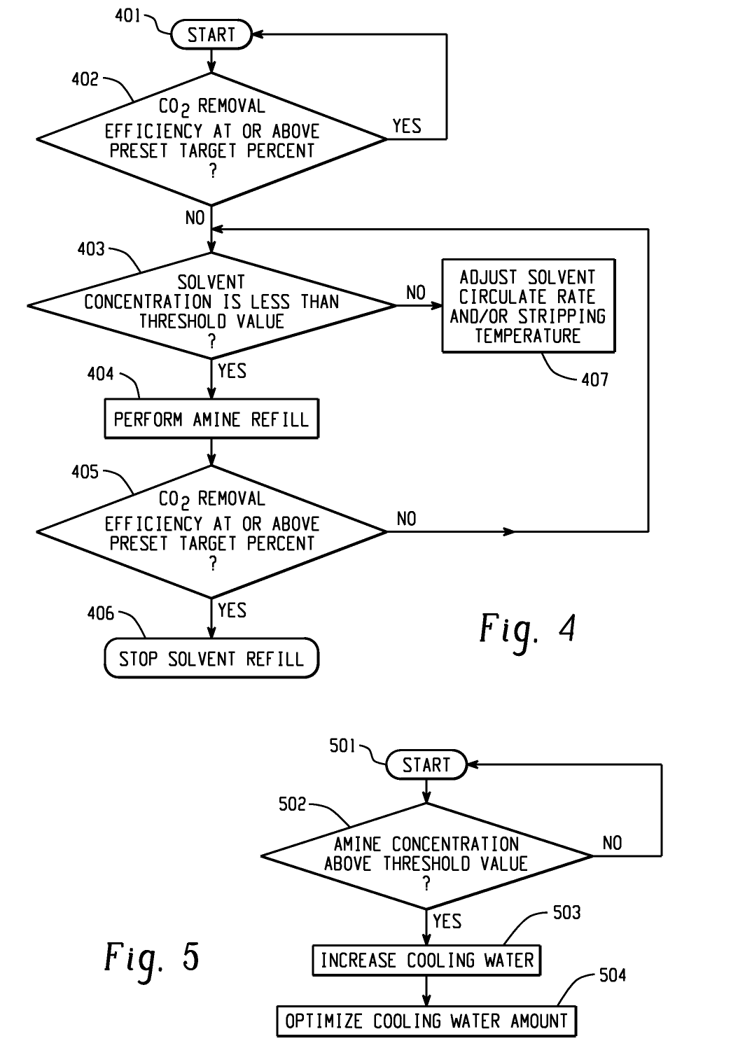

FIG. 4 illustrates a block diagram of another exemplary embodiment, which is related to fresh solvent makeup based on the data of amine concentration from probe 84 shown in FIG. 1. In this embodiment, it is first determined at block 402 as to whether the lean solvent is capable of providing the targeted removal efficiency. If yes, the control algorithm returns to the start at block 401. If no, the control then proceeds to block 403 where the solvent concentration is measured to determine level of degradation. If the solvent concentration is less than the threshold value, an amine replenish is performed at block 404 followed by an analysis at block 405 to determine whether the CO₂ efficiency reaches the target value. If the CO₂ removal efficiency meets or exceeds the targeted value, the control will perform the end of solvent make-up at block 406. If the solvent concentration is not less than the threshold value, then the controller proceeds to perform block 203 of FIG. 2.

In FIG. 5, a wash column control associated with the absorber tower is monitored. In this embodiment, carry-over amine is reduced by regulating water circulate amount according to the feedback data from the analyzer 80 in FIG. 1. The control first determines if the amine concentration is above a defined threshold value based on output data from probes 90, 92 at block 502. If not, then the control recycles to the start at block 501. If yes, the control proceeds to blocks 503 and 504 to increase the cooling water and amounts, respectively.

When the systems and methods described herein are implemented in software, the various control methods can be stored on any computer readable medium for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the control methods are implemented in hardware, the control methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

Variations, modifications, and other implementations of what is described may be employed without departing from the spirit and scope of the invention. More specifically, any of the method, system and device features described above or incorporated by reference may be combined with any other suitable method, system or device features disclosed herein or incorporated by reference, and is within the scope of the contemplated inventions. The systems and methods may be embodied in other specific forms without departing from the spirit or essential characteristics thereof The foregoing embodiments are therefore to be considered in all respects illustrative, rather than limiting of the invention. The teachings of all references cited herein are hereby incorporated by reference in their entirety.

What is claimed is:

1. A gas purification system for removal of gaseous acidic components from a gas stream, comprising:
an absorption unit comprising at least one amine based wash solution section configured to receive the gas stream comprising the acidic components to be removed and at least one water wash section downstream from the amine based wash section, wherein the at least one water wash section is configured to receive the gas stream from the amine based wash solution section, wherein the absorption unit provides a rich amine solution and a flue gas depleted of acidic gases;
a regeneration unit in fluid communication with the absorption unit for regenerating the rich amine solution from the absorption unit by removing the acidic gases therein and providing a lean amine solution for reuse in the absorption unit;
an analyzing unit comprising a plurality of sensors and/or probes for continuously analyzing a solvent cyclic capacity in real time, the plurality of sensors and/or probes in fluid communication with rich amine and lean amine solution carrying conduits and the water wash conduits; and
a system control unit configured to receive outputs from the analyzing unit for monitoring and controlling the solvent cyclic capacity in real time.

2. The gas purification system of claim 1, wherein the system control unit controls solvent regeneration, temperature and pressure of the regeneration unit to maintain the solvent cyclic capacity at a predetermined range.

3. The gas purification system of claim 1, wherein at least one of the sensors and/or probes is configured to provide an attenuated total reflectance Fourier Transform Infra Red signal representative of the solvent.

4. The gas purification system of claim 1, wherein at least one of the sensors and/or probes is configured to provide an Raman spectrum signal representative of the solvent.

5. The gas purification system of claim 1, wherein at least one of the sensors and/or probes is configured to provide a pH of the solvent.

6. The gas purification system of claim 1, wherein at least one of the sensors and/or probes is configured to provide a refractive index of the solvent.

7. The gas purification system of claim 1, wherein at least one of the sensors and/or probes is configured to provide a conductivity of the solvent.

8. The gas purification system of claim 1, wherein at least one of the sensors and/or probes is configured to provide a density of the solvent.

9. A computer implemented method for monitoring and controlling a solvent based gas purification system comprising an absorption unit and a regeneration unit, the method comprising:
receiving real time data indicative of solvent cyclic capacity from at least one sensor and/or probe in fluid communication with rich and/or lean amine solution carrying conduits and/or water wash conduits of the system; and
comparing the real time data with a predetermined threshold value; wherein in response to the real time data not meeting the predetermined threshold value, adjusting a solvent circulate rate and/or stripping temperature in the regeneration unit, and in response to the real time data meeting the predetermined threshold value, measuring a CO₂ removal efficiency percentage.

10. The computer implemented method of claim 9, wherein in response to the CO₂ removal efficiency percentage not exceeding a predetermined percentage, adjusting the solvent circulate rate and/or stripping temperature in the regeneration unit.

11. The computer implemented method of claim 9, wherein in response to the real time data meeting the predetermined threshold value, measuring lean amine loading and comparing the measured lean amine loading with a target lean amine loading level; in response to the measured lean amine loading not meeting the target lean amine loading, decreasing stripping temperature and/or adjusting solvent flow rate in response to a low lean amine loading, and increasing stripping temperature and adjusting solvent flow rate in response to a high lean amine loading.

12. The computer implemented method of claim 9, wherein in response to the CO₂ removal efficiency percentage not exceeding a predetermined percentage, measuring real time solvent concentration and comparing the measured solvent concentration with a threshold solvent concentration value, wherein in response to the measured solvent concentration meeting the threshold solvent concentration value, performing an amine refill in the absorption unit.

13. The computer implemented method of claim 9, wherein if the amine refill in the absorption unit provides a CO₂ removal efficiency percentage greater than the threshold CO₂ removal efficiency percentage, stopping the amine refill.

14. The computer implemented method of claim 9, wherein if the amine refill in the absorption unit provides a CO₂ removal efficiency percentage meeting the threshold CO₂ removal efficiency percentage, repeating the comparing of the measured solvent concentration with the threshold solvent concentration value.

15. The computer implemented method of claim 9, wherein in response to the measured solvent concentration not meeting the threshold solvent concentration value, adjusting solvent circulate rate and/or stripping temperature in the regeneration unit.

16. The computer implemented method of claim 9, wherein in response to a measured amine concentration greater than a threshold amine concentration, increasing cooling water in a water wash section of the absorption unit.
